(19) United States
(12) Patent Application Publication
(10) Pub. No.: US 2010/0077877 A1
(43) Pub. Date: Apr. 1, 2010

(54) ROTARY MICRO-ADJUSTMENT MECHANISM FOR A SYNCHRONOUS DOUBLE-DRIVE POSITIONING PLATFORM

(76) Inventors: MING-HUNG HSIEH, Taichung (TW); Cheng-Feng Lin, Taichung (TW)

Correspondence Address: Dr. BANGER SHIA, 102 Lindencrest Ct., Sugar Land, TX, 77479-5201, US

(21) Appl. No.: 12/238,566

(22) Filed: Sep. 26, 2008

(51) Int. Cl. F16H 21/02

(52) U.S. Cl. 74/25

(57) ABSTRACT

A rotary micro-adjustment mechanism for a synchronous double-drive positioning platform (such as a gantry) is disposed between a beam and support pillars of the synchronous double-drive positioning platform and comprises a positioning pillar and elastic members. The positioning pillar is provided to pivot the beam relative to the respective support pillars to compensate displacement error of the beam and the support pillars. The elastic members are provided to resist the pivotal rotation between the beam and the support pillar by their restoring force, so as to improve the rigidity of the overall mechanism.

### BACKGROUND OF THE INVENTION

1. Field of the Invention

The present invention relates to feed mechanisms for machine tools and more particularly to a rotary micro-adjustment mechanism for a synchronous double-drive positioning platform.

2. Description of the Prior Art

A conventional synchronous double-drive positioning platform A (such as a gantry), as shown in FIG. 1, comprises a beam A1 and two support pillars A2 fixed at two ends of the beam A1. A linear transmission system B is provided to drive the two support pillars A2 to move the positioning platform A, so that the two support pillars A2 which are connected to the linear transmission system B must synchronously move in order to keep the operation of the overall mechanism smooth. In this case, if the synchronous control error occurs, the displacement error of the beam A1 and the two support pillars A2 will occur consequentially, thus causing structure deformation of the synchronous double-drive positioning platform A, or even causing damage to the linear transmission system B since the two support pillars A2 are fixed to the beam A1. For this reason, a longitudinal and transverse adjustment means is provided between the beam A1 and the support pillar A2, so as to adjust the relative position of the beam A1 and the support pillar A2, thus preventing the distorted deformation of the synchronous double-drive positioning platform A. In addition, in order to improve the position compensation effect of the beam A1 and the support pillar A2, a mechanism designed to allow the beam A1 to rotate relative to the support pillar A2 has been developed.

One of the designs of allowing rotation between the beam A1 and the respective support pillars A2, as shown in FIG. 2, is provided with a motor A3 in each of the support pillars A2, and the motors A3 are connected to the beam A1. By such an arrangement, when the error of the synchronous control of the linear transmission system B connected with the support pillar A2 causes the position error between the beam A1 and the support pillar A2, the two motors A3 can control the two support pillar A2 to rotate relative to the beam A1, as shown in FIG. 3, thus compensating the position of the beam A1 and the support pillar A2. However, such a design must be additionally provided with two motors A3 in the synchronous double-drive positioning platform A, thereby greatly increasing the production cost and structure complexity.

Therefore, another design was developed on the market, as shown in FIG. 4, and it changes the support pillars A2 of the synchronous double-drive positioning platform A into thinner support pieces A4. In this case, when the error of the synchronous control of the linear transmission system B connected with the respective support pieces A4 causes the position error between the beam A1 and the two support pieces A4, since the structure of the respective support pieces A4 is relatively thin, the respective support pieces A4 can be distorted to absorb displacement error (as shown by dotted line in FIG. 4). Although no motor is needed, this type of synchronous double-drive positioning platform suffer from the disadvantage of distorted deformation, which is likely to cause the permanent deformation of the two support pieces A4, and decrease the rigidity of the synchronous double-drive positioning platform A.

The present invention has arisen to mitigate and/or obviate the afore-described disadvantages.

### SUMMARY OF THE INVENTION

The primary objective of the present invention is to provide a rotary micro-adjustment mechanism for a synchronous double-drive positioning platform, which utilizes a positioning pillar to pivot a beam to support pillars of the synchronous double-drive positioning platform, and provides elastic members between the beam and the support pillar, so as to allow the beam to pivot relative to the support pillar through the positioning pillar to perform position compensation and utilize the elastic members to increase the rigidity between the beam and the support pillar.

In order to achieve the above objective, the rotary micro-adjustment mechanism is disposed between the beam and the support pillars of the synchronous double-drive positioning platform and comprises a positioning pillar and at least two elastic members. The positioning pillar pivots the beam to the support pillars. The respective elastic members are disposed between the beam and the support pillars and abut against both sides of the beam.

When displacement error of the beam and the two support pillars of the synchronous double-drive positioning platform occurs, the beam can pivot relative to the respective support pillar about the positioning pillar to perform position compensation of the beam and the respective support pillars. Furthermore, when the beam pivots relative to the respective support pillars, the elastic members at one side of the beam will be compressed, so that the elastic members can resist the beam from pivoting relative to the support pillars, thus improving the rigidity between the beam and the respective support pillars.

### BRIEF DESCRIPTION OF THE DRAWINGS

FIG. 1 is a perspective view of a conventional synchronous double-drive positioning platform;

FIG. 2 is a schematic view illustrating that another conventional synchronous double-drive positioning platform, which is provided with motors;

FIG. 3 is a schematic view showing that the beam and the support pillars of the conventional synchronous double-drive positioning platform pivot relative to each other to perform position compensation;

FIG. 4 is a perspective view illustrating how the distorted support pieces perform the position compensation;

FIG. 5 is an exploded view illustrating how a rotary micro-adjustment mechanism for a synchronous double-drive positioning platform in accordance with the present invention is disposed on the synchronous double-drive positioning platform;

FIG. 6 is a cross-sectional view illustrating how the rotary micro-adjustment mechanism for a synchronous double-drive positioning platform in accordance with the present invention is disposed on the synchronous double-drive positioning platform; and

FIG. 7 is a schematic view illustrating that the elastic members at one side of the beam are compressed.

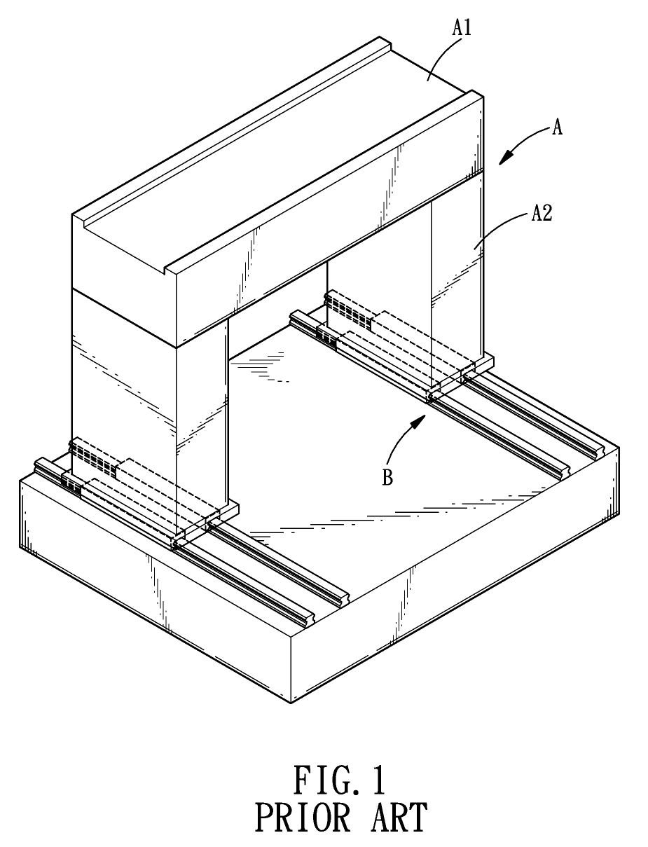

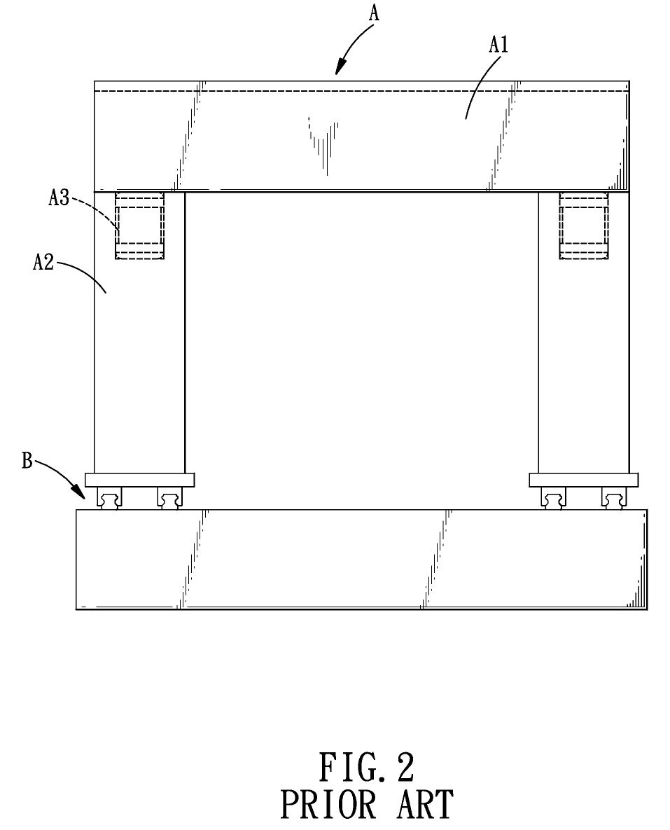

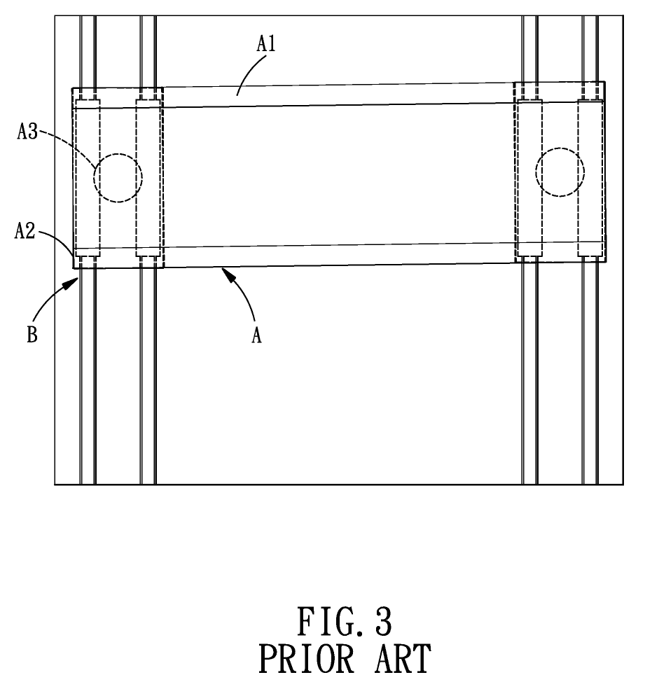

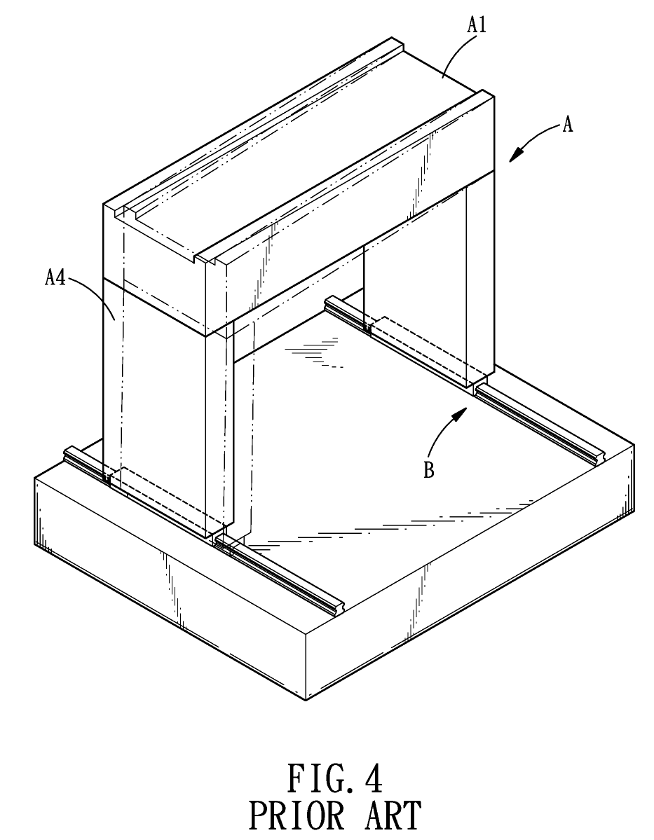

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

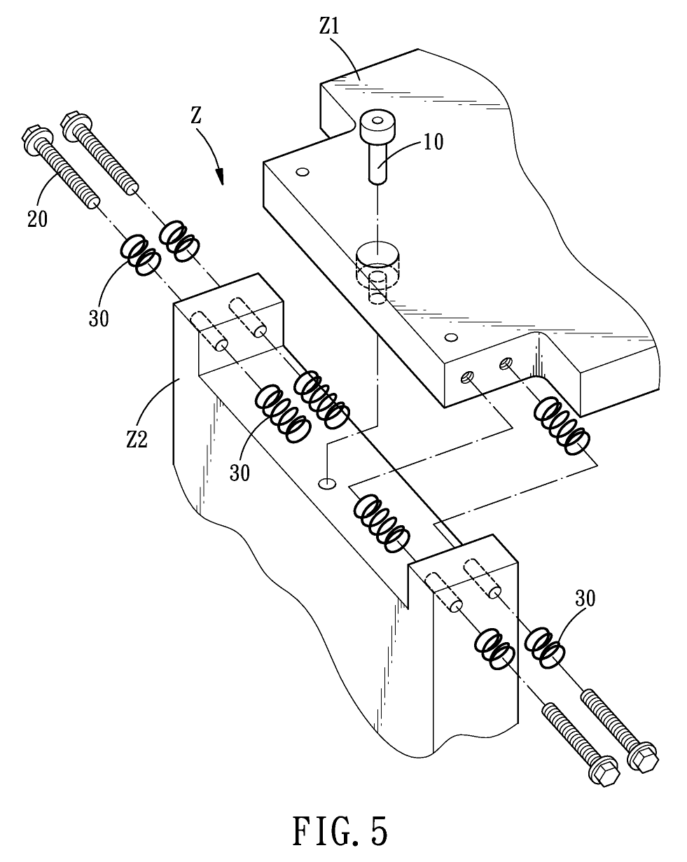

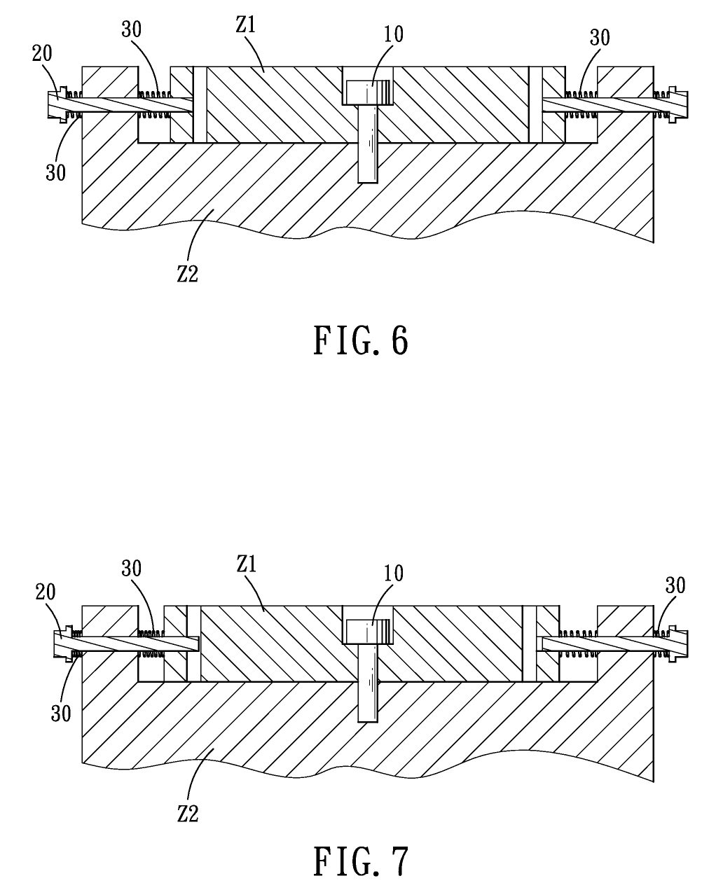

Referring to FIGS. 5-6, a rotary micro-adjustment mechanism for a synchronous double-drive positioning platform in accordance with a preferred embodiment of the present invention is disposed between a beam Z1 and two support pillars Z2 of the synchronous double-drive positioning platform Z and comprises a positioning pillar 10, four mounting pillars 20, and eight elastic members 30.

One end of the positioning pillar 10 is inserted into the support pillar Z2 through the beam Z1 in such a manner that the beam Z1 is pivoted to the support pillar Z2 through the positioning pillar 10.

The four mounting pillars 20 connect the beam Z1 to the support pillar Z2 in the radial direction of the positioning pillar 10 in such a manner that two of the mounting pillars 20 connect one side of the support pillar Z2 to one side of the beam Z1, and the other two of the mounting pillars 20 connect the other side of the support pillar Z2 to the other side of the beam Z1. In the present embodiment, each of the mounting pillars 20 has one end formed with threads. The end of each of the mounting pillars 20, which is formed with threads, is inserted through the respective support pillars Z2 and then screwed in the beam Z1, so that the beam Z1 is connected to the respective support pillar Z2.

Each of the mounting pillars 20 is provided with two of the eight elastic members 30 in such a manner that one of the two elastic members 30 of each of the mounting pillars 20 is located between the mounting pillar 20 and the support pillar Z2, and the other of the two elastic members 30 of each of the mounting pillars 20 is located between the beam Z1 and the support pillar Z2. Moreover, four of the elastic members 30 are located at one side of the beam Z1, and the other four of the elastic members 30 are located at the other side of the beam Z1. The elastic members 30 in the present embodiment are springs, and they can also be elastic metal or plastic plates, elastic rubber blocks, etc.

When the displacement error of the beam Z1 and the two support pillars Z2 of the synchronous double-drive positioning platform Z occurs, since the beam Z1 is pivoted to the support pillar Z2 through the positioning pillar 10, adjusting the depth at which the mounting pillars 20 are screwed in the beam Z1 can make the beam Z1 pivot relative to the respective support pillar Z2, so as to compensate the position of the beam Z1 relative to the support pillar Z2, thus preventing the distorted deformation of the synchronous double-drive positioning platform Z.

When the beam Z1 pivots relative to the support pillar Z2, as shown in FIG. 7, the elastic members 30 at one side of the beam Z1 will be compressed, so that the compressed elastic members 30 will resist the beam Z1 from pivoting relative to the support pillar Z2 by their elastic restoring force, thereby increasing the rigidity between the beam Z1 and the support pillar Z2. When the elastic member 30 reaches its maximal deformation, the user will be reminded that if the beam Z1 continues pivoting relative to the support pillar Z2, the synchronous double-drive platform Z2 will be distorted. This arrangement can remind the user that the displacement error of the two support pillars Z2 has reached the maximum.

Additionally, the respective elastic members 30 can also be fixedly connected to the beam Z1 and the support pillar Z2, so that when the beam Z1 pivots relative to the support pillar Z2 and compresses the elastic members 30 located at one side of the beam Z1, the elastic members 30 located at the other side of the beam Z1 will be extended, thereby further improving the rigidity between the beam Z1 and the support pillar Z2.

The number of the mounting pillars 20 and the elastic members 30 used in the rotary micro-adjustment mechanism of the present invention is not limited to four and eight, as long as both sides of the beam Z1 are provided with the elastic members 30, such as two or more.

Moreover, the respective elastic members 30 are not limited to the springs shown in the drawings, they can also be the above elastic metal or plastic plates, elastic rubber block or other objects that are flexible and have elastic restoring force. In addition, using the pneumatic, hydraulic cylinders and other pressure-stored restoration devices to substitute the respective elastic members 30 can also realize the effect of increasing the rigidity between the beam Z1 and the respective support pillars Z2.

While we have shown and described various embodiments in accordance with the present invention, it is clear to those skilled in the art that further embodiments may be made without departing from the scope of the present invention.

What is claimed is:

1. A rotary micro-adjustment mechanism for a synchronous double-drive positioning platform disposed between a beam and two support pillars, comprising:
a positioning pillar pivoting the beam to the support pillar in such a manner that the beam pivots relative to the support pillar about the positioning pillar to perform position compensation; and
at least two elastic members being respectively disposed between the beam and the support pillar and abutting against both sides of the beam, the beam pivoting relative to the support pillar to compress the elastic member at one side of the beam, the compressed elastic members resisting the beam from pivoting relative to the support pillar by their restoring force, so as to increase rigidity between the beam and the support pillar.

2. The rotary micro-adjustment mechanism for a synchronous double-drive positioning platform as claimed in claim 1, the elastic members are disposed between the beam and the support pillars in a radial direction of the positioning pillar.

3. The rotary micro-adjustment mechanism for a synchronous double-drive positioning platform as claimed in claim 1, wherein one end of the positioning pillar is inserted into the support pillar through the beam.

4. The rotary micro-adjustment mechanism for a synchronous double-drive positioning platform as claimed in claim 1, wherein both ends of the respective elastic members are fixedly connected to the beam and the support pillars.

5. The rotary micro-adjustment mechanism for a synchronous double-drive positioning platform as claimed in claim 1, wherein plural mounting pillars connect the beam to the respective support pillars in the radial direction of the positioning pillar, and the mounting pillars connect the beam to the respective support pillars in such a manner that both sides of the respective support pillars clamp the beam.

6. The rotary micro-adjustment mechanism for a synchronous double-drive positioning platform as claimed in claim 5, wherein one end of the respective mounting pillars is formed with threads, and the end of the respective mounting pillars, which is formed with the threads, is inserted through the respective support pillars and then screwed in the beam.

7. The rotary micro-adjustment mechanism for a synchronous double-drive positioning platform as claimed in claim 1, wherein the elastic members are selected from the group consisting of springs, elastic metal or plastic plates, elastic rubber blocks, etc.
